(19) United States
(12) Patent Application Publication
(10) Pub. No.: US 2026/0309497 A1
(43) Pub. Date: Oct. 8, 2026

(54) INTELLIGENT ASSISTIVE BLIND GUIDANCE SYSTEM AND METHOD BASED ON AUDIO-VISUAL FUSION AND HAPTIC FEEDBACK

(71) Applicant: SHANDONG UNIVERSITY, Jinan (CN)

(72) Inventors: Huanghe ZHANG, Jinan (CN); Yuqing LIU, Jinan (CN); Xinshuai GAO, Jinan (CN); Liang YUAN, Jinan (CN); Yanzi LU, Jinan (CN); Yibin LI, Jinan (CN); Rui SONG, Jinan (CN)

(21) Appl. No.: 19/413,002

(22) Filed: Dec. 9, 2025

(30) Foreign Application Priority Data
Apr. 8, 2025 (CN) 2025104346613

(51) Int. Cl. G01C 21/00; B62D 57/032; G01C 21/20; G05D 1/686; G05D 105/70; G05D 109/12; G06V 20/58; G06V 40/10; G08B 6/00; G10L 15/22

(52) U.S. Cl. CPC G01C 21/005; B62D 57/032; G01C 21/20; G05D 1/686; G06V 20/58; G06V 40/10; G08B 6/00; G10L 15/22; G05D 2105/70; G05D 2109/12; G10L 2015/223

(57) ABSTRACT

Provided is an intelligent assistive blind guidance system and method based on audio-visual fusion and haptic feedback, may include a robotic guide dog and a guide cane. The robotic guide dog includes a robotic guide dog main body and a quadruped drive device. The robotic guide dog main body comprises a vision module, a voice interaction module, a data processing module, and a control module. A top handle of the guide cane comprises a haptic feedback module. A surrounding environment map is constructed based on surrounding environment information, and a planned path and a movement strategy are generated with reference to a voice instruction of a user and a pushing and pulling force of the user, to generate a walking prompt instruction and a drive instruction, drive the robotic guide dog to perform assistive blind guidance, and provide haptic vibration feedback based on the walking prompt instruction.

### CROSS-REFERENCE TO RELATED APPLICATIONS

The present invention claims priority to Chinese Patent Application No. 202510434661.3, filed with the China National Intellectual Property Administration on Apr. 8, 2025 and entitled “INTELLIGENT ASSISTIVE BLIND GUIDANCE SYSTEM AND METHOD BASED ON AUDIO-VISUAL FUSION AND HAPTIC FEEDBACK”, which is incorporated herein by reference in its entirety and constitutes a part of the present invention, for all purposes.

### TECHNICAL FIELD

The present invention relates to the field of intelligent assistive technologies, and in particular, to an intelligent assistive blind guidance system and method based on audio-visual fusion and haptic feedback.

### BACKGROUND

The description in this section merely provides background information related to the present invention and does not necessarily constitute the prior art.

In recent years, with continuous progress of technologies, more and more intelligent assistive devices are used for helping the visually impaired to resolve problems in life. As a long-term used assistive tool, a conventional guide dog for the blind plays an important role, but also has some disadvantages that cannot be ignored: first, training costs are high and a training period is long, the guide dog for the blind can be put into use only after professional training for 2 to 3 years, and each guide dog has high training costs, depends on a physical condition of an animal, and has a limited working period; secondly, life management and a working environment are limited, the guide dog needs regular feeding, health management, and psychological training, and the guide dog can be used only in a limited environment, and is not applicable to all scenarios; and the conventional guide dog has poor environmental adaptability, in a complex urban environment, busy traffic, or in a place with dynamic change, working efficiency and response capacity of the guide dog are limited, and there is a risk.

With the progress of science and technologies, the existing intelligent assistive devices, such as an intelligent guide cane and a voice assistant, are also started to be used by the visually impaired. However, most of these devices rely on manual operations of users, cannot adapt to complex dynamic environments, and have relatively large limitations. The existing intelligent guide cane can provide only obstacle perception and simple navigation guidance, cannot implement automatic path planning and real-time obstacle avoidance, cannot implement adaptive assistive adjustment in different scenarios, and cannot ensure user safety.

### SUMMARY

To resolve the foregoing shortcomings of the existing technology, the present invention provides an intelligent assistive blind guidance system and method based on audio-visual fusion and haptic feedback. By integrating multi-sensor technologies, voice interaction technologies, and a haptic feedback mechanism, the system and method can adapt to path planning, autonomous navigation, and real-time obstacle avoidance in various complex environments, and can provide a travel assistive function with high intelligence, automation, and reliability for the visually impaired, thereby ensuring travel safety of users, and avoiding the following problems: a conventional assistive blind guidance device needs to be manually operated, cannot adapt to a complex dynamic environment, and cannot implement adaptive assistive adjustment.

According to a first aspect, the present invention provides an intelligent assistive blind guidance system based on audio-visual fusion and haptic feedback.

An intelligent assistive blind guidance system based on audio-visual fusion and haptic feedback, where the system includes a robotic guide dog and a guide cane, the robotic guide dog includes a robotic guide dog main body and a quadruped drive device, and the robotic guide dog main body includes:
a vision module, configured to sense surrounding environment information in real time;
a voice interaction module, configured to: perform voice interaction with a user, receive a voice instruction of the user, and feed back a voice navigation prompt based on a walking prompt instruction;
a data processing module, configured to: construct a surrounding environment map based on received surrounding environment information, and generate a planned path and a movement strategy with reference to the voice instruction of the user, the movement strategy including a current required walking speed; and
a control module, configured to generate, based on the planned path and the movement strategy with reference to the voice instruction of the user and a pushing and pulling force of the user, a walking prompt instruction and a drive instruction used for driving the quadruped drive device; and
a top handle of the guide cane includes a haptic feedback module, the haptic feedback module includes a vibration device and a force sensor configured to sense the pushing and pulling force of the user, and the vibration device is configured to provide haptic vibration feedback based on the walking prompt instruction.

According to a second aspect, the present invention provides an intelligent assistive blind guidance method based on audio-visual fusion and haptic feedback, which is implemented based on the intelligent assistive blind guidance system based on audio-visual fusion and haptic feedback proposed in the first aspect, and includes:
sensing surrounding environment information in real time, receiving a voice instruction of a user, and sensing a pushing and pulling force of the user for a guide cane;
constructing a surrounding environment map based on the received surrounding environment information, and generating a planned path and a movement strategy with reference to the voice instruction of the user, the movement strategy including a current required walking speed; and
generating a walking prompt instruction and a drive instruction based on the planned path and the movement strategy with reference to the voice instruction of the user and the pushing and pulling force of the user, performing haptic vibration feedback and voice feedback based on the walking prompt instruction, and driving a robotic guide dog to perform assistive blind guidance based on the drive instruction.

According to a third aspect, the present invention further provides an electronic device, including a memory, configured to store an executable instruction; and a processor, configured to implement, when executing the executable instruction stored in the memory, the intelligent assistive blind guidance method based on audio-visual fusion and haptic feedback.

According to a fourth aspect, the present invention further provides a computer-readable storage medium, storing an executable instruction, and configured to cause a processor, when executing the executable instruction, to implement the intelligent assistive blind guidance method based on audio-visual fusion and haptic feedback.

According to a fifth aspect, the present invention further provides a computer program product, the computer program product includes an executable instruction, and the executable instruction is stored in a computer-readable storage medium, where a processor of an electronic device reads the executable instruction from the computer-readable storage medium, and implements, when executing the executable instruction, the intelligent assistive blind guidance method based on audio-visual fusion and haptic feedback.

The foregoing one or more technical solutions have the following beneficial effects.
1. The present invention provides an intelligent assistive blind guidance system and method based on audio-visual fusion and haptic feedback. By integrating multi-sensor technologies, voice interaction technologies, and a haptic feedback mechanism, the system and method can adapt to path planning, autonomous navigation, and real-time obstacle avoidance in various complex environments, and can provide a travel assistive function with high intelligence, automation, and reliability for the visually impaired, thereby ensuring travel safety of users, and avoiding the following problems: a conventional assistive blind guidance device needs to be manually operated, cannot adapt to a complex dynamic environment, and cannot implement adaptive assistive adjustment.
2. The intelligent assistive blind guidance system and method based on audio-visual fusion and haptic feedback provided in the present invention creatively provide an audio-visual-haptic fusion method. By integrating multi-sensor with deep fusion of audio-visual-haptic modules, the system can sense an environment change in real time, dynamically adjust a navigation strategy, and provide multi-sensory navigation guidance for a user by using a voice and haptic feedback. This fusion mechanism not only improves an intelligence level of the system, but also improves safety and use experience of the user, resolves problems such as a long training period and a poor environment adaptation capability of a conventional guide dog, and provides a high-efficient, intelligent, and safe travel assistance solution for the visually impaired. In addition, the voice interaction function enables the visually impaired to interact with the robot by using a voice, thereby reducing dependency on another assistive device. The haptic feedback mechanism further enhances interactivity and safety of the system, so that the user can sense an environment change through touch. Design of the emergency stop function and the obstacle avoidance function further enhances safety performance of the system, thereby ensuring user safety.

Advantages of additional aspects of the present invention will be partly set forth in the following description, and will become apparent in part from the following description, or may be learned from practice of the present invention.

### BRIEF DESCRIPTION OF THE DRAWINGS

The accompanying drawings constituting a part of the present invention are used to provide a further understanding of the present invention. The exemplary embodiments of the present invention and descriptions thereof are used to explain the present invention, and do not constitute an improper limitation of the present invention.

FIG. 1 is a schematic diagram of a robotic guide dog according to an example of the present invention;

FIG. 2 is a schematic diagram of a module design of an intelligent assistive blind guidance system according to an example of the present invention;

FIG. 3 is a schematic diagram of a guide cane according to an example of the present invention;

FIG. 4 is a flowchart of a three-aspect fusion mechanism of audio-visual-haptic according to an example of the present invention; and

FIG. 5 is a flowchart of path planning and decision-making according to an example of the present invention.

Wherein: 1, guide cane; 2, folding joint; 3, light detection and ranging (LiDAR); 4, camera; 5, robotic guide dog main body; 6, quadruped drive device; 7, handle; 8, battery; 9, indicator light; 10, traction connection device; 11, vibration device; 12, force sensor; and 13, guide cane shaft.

### DETAILED DESCRIPTION

It should be noted that the following detailed descriptions are exemplary, and are merely for describing specific implementations, are intended to provide further descriptions of the present invention, and are not intended to limit exemplary implementations according to the present invention. Unless otherwise specified, all technical and scientific terms used in this specification have the same meanings as those usually understood by a person of ordinary skill in the art to which the present invention belongs. Furthermore, it should further be understood that the terms “comprise/comprising” and/or “include/including”, when used in this specification, indicate the presence of features, steps, operations, devices, components, and/or combinations thereof.

### Example 1

The present example provides an intelligent assistive blind guidance system based on audio-visual fusion and haptic feedback. By integrating multi-sensor technologies, voice interaction technologies, and a haptic feedback mechanism, the system can adapt to path planning, autonomous navigation, and real-time obstacle avoidance in various complex environments, and can provide a travel assistive function with high intelligence, automation, and reliability for the visually impaired, thereby ensuring travel safety of users, and avoiding the following problems that affect user safety: a conventional assistive blind guidance device needs to be manually operated, cannot adapt to a complex dynamic environment, and cannot implement adaptive assistive adjustment.

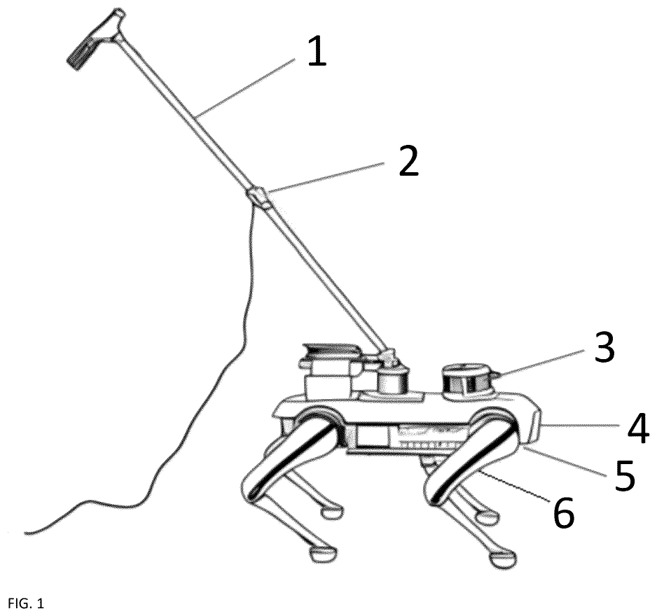

As shown in FIG. 1, the intelligent assistive blind guidance system provided in the present example includes a robotic guide dog and a guide cane 1. The end of the guide cane 1 is connected to the autonomously movable robotic guide dog. The guide cane 1 may implement universal rotation in space relative to the robotic guide dog. The robotic guide dog includes a robotic guide dog main body 5 (also referred to as a robotic guide dog chassis) and a quadruped drive device 6. The quadruped drive device 6 includes quadruped legs for supporting the entire robotic guide dog main body and a drive module for driving operation of the quadruped legs, so that the robotic guide dog walks smoothly on various grounds and implements obstacle avoidance and steering functions. The robotic guide dog main body 5 is configured to drive the entire system to operate. The robotic guide dog main body is made of high-strength aluminum alloy, and is subjected to precise mechanical processing and structural optimization design, to ensure sufficient strength and stability to support the entire system. The quadruped drive device mounted below the main body includes four legs. In addition, the main body further integrates an advanced vibration reduction system, including a suspension spring and a hydraulic shock absorber. This can effectively filter out road bumps, provide guarantee for stable operation of the robot, and ensure that measurement accuracy of the sensor and system stability are not affected due to excessive vibration when driving on complex terrains.

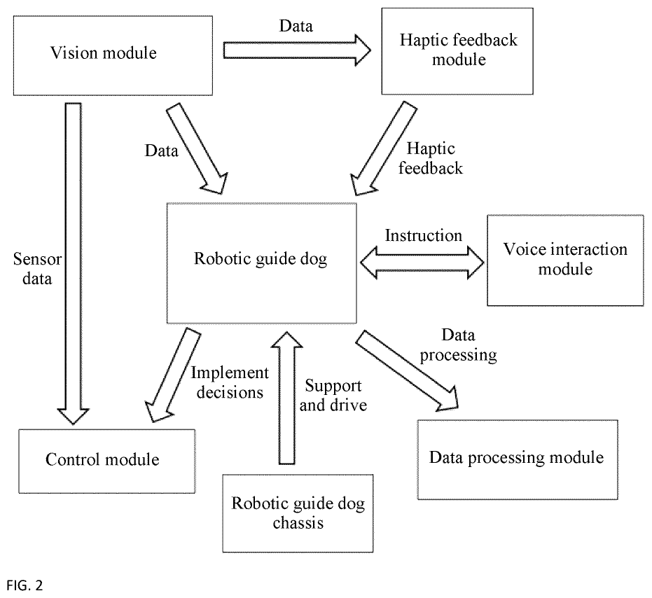

Further, as shown in FIG. 2, the robotic guide dog main body includes a vision module, a voice interaction module, a data processing module, and a control module, and a top handle of the guide cane includes a haptic feedback module. Various modules set in the system are introduced in more detail by using the following content.
(1) Vision module, configured to sense surrounding environment information in real time.

The vision module includes a LIDAR, ultrasonic sensors, a camera, and an inertial measurement unit (IMU), configured to sense surrounding environment information in real time, such as static and dynamic obstacles, a traffic sign, a pedestrian posture, a road boundary, and a speed and an acceleration of the robotic guide dog. Spatial positioning may be performed based on the surrounding environment information to construct a high-definition map of surrounding environment, thereby ensuring that the user can walk safely and efficiently, and avoiding collision with an obstacle.

The LiDAR 3 is installed on an adjustable pan-tilt at the top of the robotic guide dog main body, and implements 360-degree omni-directional scanning by using an accurate mechanical structure and an angle sensor. The LiDAR accurately measures a distance from a surrounding object and contour information of the surrounding object by emitting a laser beam, can work stably even in an environment with dark light or some interference, and provides key basic data for environment sensing and map construction.

The ultrasonic sensors are evenly distributed around the periphery of the robotic guide dog main body, to perform supplementary detection on a small obstacle, a low object, or a LIDAR scanning blind area within a short distance range, thereby optimizing a working frequency, avoiding signal interference with other sensors, and detecting potential danger around in a timely and accurate manner.

The camera 4 is an industrial camera with a high resolution and a wide dynamic range, is installed at particular positions in front of and at two sides of the robotic guide dog main body, has optical image stabilization and automatic focusing functions, and clearly captures an environment image. A lens is made of a special optical glass material, has good light transmission and anti-soiling property, adapts to different lighting conditions (such as direct strong light, backlight, and weak light), provides rich visual data for a deep learning algorithm, and is used for recognizing information such as a traffic sign, a pedestrian posture, and a road boundary.

The IMU is closely integrated at a core position inside the robotic guide dog main body. Changes of a posture, acceleration, and an angular velocity of the robotic guide dog are monitored in real time by using a high-precision accelerometer and gyroscope. A sensor chip uses an advanced MEMS technology, has features of low noise and high sensitivity, ensures accurate measurement of a motion state of the robotic guide dog in a complex motion process, and provides key motion information for navigation and positioning.
(2) Voice interaction module, configured to: perform voice interaction with a user, receive a voice instruction of the user, and feed back a voice navigation prompt based on a walking prompt instruction.

The voice interaction module is configured to: perform voice interaction with the user, receive the voice instruction, such as a voice navigation instruction, which is input by the user through voice, and transmit the voice instruction of the user to the control module. The control module then adjusts a travel state of the robot (that is, the robotic guide dog) based on the instruction. In addition, the control module may generate a walking prompt instruction based on an actual navigation situation, and provides real-time navigation prompts, obstacle warnings, path adjustment information, and the like through voice feedback, such as “Forward”, “Stop”, “Turn left”, “Turn right”, “There is an obstacle 50 meters ahead, please go around”, or “You have arrived at your destination”. In an emergency, the user is prompted with a current environmental condition through voice, such as “The obstacle ahead is too close, please stop”, so that the user makes corresponding adjustment.

Further, the voice interaction module selects a highly sensitive microphone array, and enhances a voice signal receiving effect by using a beamforming technology, thereby effectively suppressing environmental noise interference, and accurately identifying a user voice instruction in a noisy outdoor environment. The microphone array uses a special acoustic structure design and a signal processing algorithm, and can focus and enhance speech signals from different directions, thereby improving speech recognition robustness. In addition, the voice interaction module includes a loudspeaker, which uses a high-quality audio chip and a high-power amplifier, and outputs a clear, loud, and natural voice prompt. A volume may be automatically adjusted based on environmental noises, to ensure that the user can clearly hear navigation information and warnings in different scenarios. In addition, the voice interaction module further supports selection of a plurality of languages and voice timbres, and the user may perform personalized setting based on requirements of the user.

Preferably, the voice interaction module may further be set at the handle of the guide cane 1, to more clearly obtain the voice instruction of the user and broadcast the navigation prompt, so that the user can more clearly hear navigation information and warning information.
(3) Data processing module, configured to: construct a surrounding environment map based on received surrounding environment information, and generate a planned path and a movement strategy with reference to the voice instruction of the user, the movement strategy including a current required walking speed.

In the present example, the data processing module is equipped with a large-capacity high-speed memory and a professional graphics processing unit (GPU), for example, a high-performance GPU chip of NVIDIA, configured to accelerate operations. A storage device uses a solid state disk (SSD), has a fast data reading and writing speed and high reliability, meets fast storage and reading requirements of a large quantity of map data, training models, and environment information, and ensures timeliness of data processing and a system response speed. In addition, a dedicated operating system and software platform, such as a Linux-based robot operating system (ROS), and related development tools and library files are further installed, to facilitate algorithm development and system debugging.

The data processing module is configured to process data from a sensor, analyze an environment condition, and generate a path planning solution, and has a fast data processing capability, to support real-time navigation and obstacle avoidance decisions. In addition, the data processing module extracts information such as a quantity of pedestrians, a pedestrian speed, and a distance from an obstacle based on current surrounding environment information provided by the vision module, to calculate an optimal movement strategy, that is, an average safe walking speed that the user is advised to adjust.

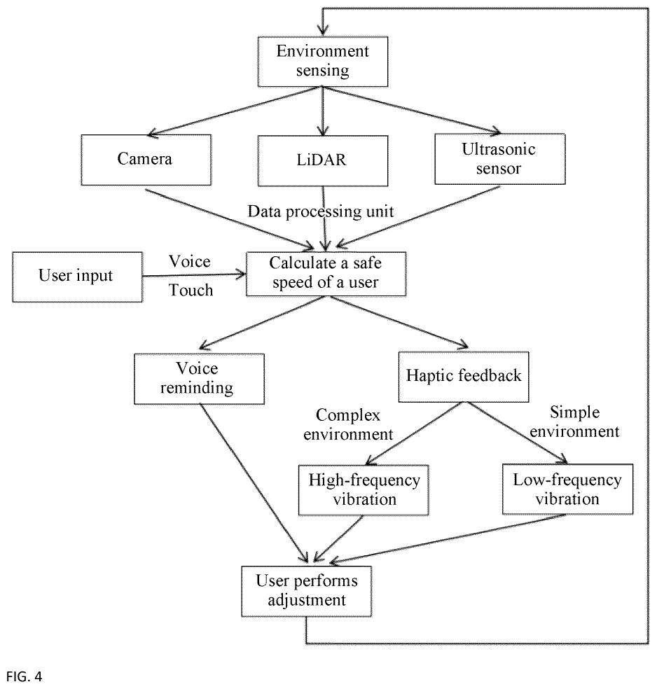

Specifically, the plurality of sensors in the vision module are used to collect the surrounding environment information, including point cloud data of the LiDAR, image data of the camera, distance data of the ultrasonic sensor, and motion data of the IMU. The collected data is transmitted to the data processing module, and the data processing module performs real-time processing and fusion on the data, to perform path planning. As shown in FIG. 4, the following steps are included.

First, the surrounding environment information is obtained in real time by using the camera, the LiDAR, the ultrasonic sensor, and the like, and a surrounding terrain, types and states of static and dynamic obstacles (such as a pedestrian and a vehicle), the motion state of the robotic guide dog, and the like are detected and identified in real time based on the obtained surrounding environment information. Specifically, the point cloud data collected by the LiDAR is filtered and segmented, to remove noise points and invalid data, and the point cloud data is divided into different object and terrain regions by using a clustering algorithm; image recognition and semantic annotation are performed on the segmented region with reference to texture and color information in a camera image, for example, identifying a road, a building, a pedestrian, a vehicle, or an obstacle; and precise estimation and compensation are performed on the motion state of the robot by using the motion data of the IMU, to ensure accuracy and stability of environment sensing.

Then, environment analysis is performed based on the foregoing processed data by using the deep learning algorithm, to construct a high-definition map model. The map model uses a grid-based representation method. Environment information, such as a terrain type, obstacle distribution, and a trafficability probability, of a corresponding position is stored in each grid unit.

Finally, environment analysis and optimal path planning are performed by using an improved A* algorithm in combination with a deep reinforcement learning algorithm based on the constructed map model and destination information clarified based on the voice instruction of the user, and an optimal path from a current position to a destination is searched for on the map.

In the present example, the existing A* algorithm is improved by improving an evaluation function. Specifically, compared with a conventional evaluation function, the present example introduces a dynamic weight adjustment mechanism and a local re-planning mechanism, and integrates user preferences, to implement better path planning. An evaluation function of the improved A* algorithm is:

$$f ( n ) = [ g ( n ) + λ \cdot T ( n ) ] + [ {w}^{1} \cdot h ( n ) + {w}^{2} \cdot D ( n ) + {w}^{3} \cdot C ( n ) ] ;$$

wherein, g(n) represents a historical movement cost from a start point to a node n; T(n) represents a terrain trafficability cost coefficient, a ground type is identified through LiDAR point cloud segmentation, posture feedback data of the IMU is combined for fusion calculation, to quantify a trafficability difficulty of terrain (such as grasslands, steps, or slopes), and a quantified value is used as the terrain trafficability cost coefficient; h(n) is a conventional heuristic function, and an Euclidean distance from the node n to a target point is adopted; D(n) represents a dynamic obstacle density factor, based on real-time data from the ultrasonic sensor and the camera, a distribution density of obstacles within a preset radius around the node n is calculated and is used as the dynamic obstacle density factor; C(n) represents a user preference coefficient that is generated based on a preset personalized requirement (such as quietness, flatness, or avoidance regions) and calculated through semantic map matching; and, λ, w₁, w₂, and w₃ are weight parameters, and dynamic optimization of the weight parameter is performed by using a deep reinforcement learning module, to balance priorities of the terrain, the obstacle, and the user preference.

Based on the foregoing set evaluation function, when the sensor detects an environmental change (such as a sudden obstacle or a terrain change), the deep reinforcement learning module updates parameters such as λ and w₂ in real time, prioritizes reducing a traversal weight of a high-risk region, to realize dynamic adjustment of the weight; if D(n) of a node in a current path exceeds a safety threshold, such as in a densely populated pedestrian region, it may trigger a local path re-search and planning to avoid global duplicate calculation; and C(n) is embedded in the heuristic function, for example, when the user selects “Quiet route”, a trafficability cost of a noisy region (the region may be identified through camera-based semantic recognition) may be automatically increased.

The foregoing improved A* algorithm is adopted, so that a travel route can be dynamically selected based on a current surrounding environment and a user requirement in a search process. That is, a kinematic model of the robot, environmental obstacle information, and a preference setting of the user are comprehensively considered, a path with high safety and few obstacles is preferentially selected, and a preference of the user is also considered, such as avoiding busy traffic regions and selecting a quiet route. Costs of different paths are evaluated based on the foregoing considered factors with reference to the heuristic function, to preferentially select a path with low costs, thereby implementing optimal path planning that better satisfies an actual situation and the user requirement, further improving a path planning effect, and effectively adapting to a complex dynamic environment.

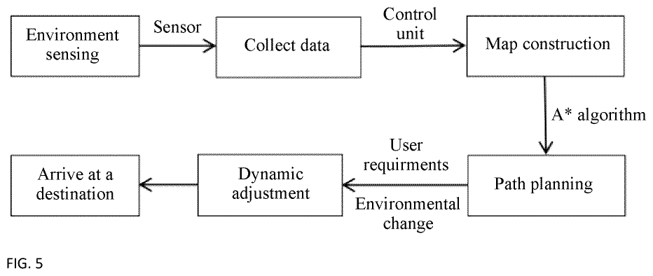

Further, as shown in FIG. 5, dynamic programming technologies are used to record and optimize a searched path, to avoid repeated searching and collapsing in a local optimal solution. In addition, a planned path is adjusted in real time based on an actual situation, such as a real-time position of the robot and an environment change. When an obstacle or a complex environment change is detected, the robot can automatically select a new path to ensure avoiding the obstacle, thereby ensuring that the robot can safely and efficiently arrive at a destination.

In another implementation, when the surrounding environment map is constructed, and path planning is performed, in the present example, a movement strategy for safe movement of the user is further developed based on an actual situation. The movement strategy includes a current required walking speed, that is, based on environmental visual information captured by the camera, with reference to data collected by the LiDAR and the ultrasonic sensor, an environment sparsity and maximum and minimum safe walking speeds of the user are obtained through calculation of the data processing module.

Specifically, a surrounding terrain, types and states of static and dynamic obstacles (such as a pedestrian and a vehicle), the motion state of the robotic guide dog, and the like are detected and identified in real time based on the obtained surrounding environment information. Based on this, the environment sparsity is calculated based on a quantity of pedestrians, a pedestrian speed, and a distance between the robotic guide dog and a nearest obstacle that are detected in real time in a current scenario, where a calculation formula is:

$$A = \frac{1}{{k}_{1} \cdot N + {k}_{2} \cdot {V}_{avg} + {k}_{3} \cdot \frac{1}{{d}_{min}}} ;$$

wherein, N is a quantity of pedestrians detected in a current environment, V_{avg} is an average speed of pedestrians in the current environment, the pedestrian in the environment is detected by using a camera and the LiDAR, and a speed vᵢ of each pedestrian is calculated, to further calculate an average speed of pedestrians in a crowd by using

$${V}_{avg} = \frac{1}{N} {\sum }_{i = 1}^{N} {v}_{i} ;$$

dₘᵢₙ is the distance between the robotic guide dog and the nearest obstacle, and the distance dₘᵢₙ between the robotic guide dog and the nearest obstacle is detected by using the LiDAR or the ultrasonic sensor; and k₁, k₂, and k₃ are weight coefficients, used for adjusting impact of the quantity of pedestrians, the pedestrian speed, and the distance from the obstacle on the environment sparsity.

Then, the current required walking speed, that is, a recommended walking speed of the user, is generated based on the environment sparsity with reference to a preset reference walking speed of the user. A minimum safe speed Vₘᵢₙ and a maximum safe speed Vₘₐₓ recommended for the user to walk are calculated as following:

$${V}_{min} = {V}_{base} \cdot ( 1 - α \cdot ( 1 - A ) ) ;$$

$${V}_{max} = {V}_{base} \cdot ( 1 + β \cdot A ) ;$$

wherein, V_{base} is a reference walking speed of the user, and a and B are adjustment coefficients, used for controlling a safe speed range.

In addition, a current real-time speed V_{current} of a blind user is calculated based on the motion state of the robotic guide dog, and a calculation formula is:

$${V}_{current} = f \times s \times n ;$$

wherein, f is a step frequency, representing a quantity of steps taken by the robotic guide dog per second; s is a step length, representing a distance for each step of the robotic guide dog; and, n is a gait coefficient, representing a proportion of effective steps per unit time.

The weight coefficient, the adjustment coefficient, the gait coefficient, and the like may all be set based on a specific situation and a user preference. For example, a weight of the quantity of pedestrians is k₁=0.3, a weight of the pedestrian speed is k₂=0.1, a weight of the distance from the obstacle is k₃=0.8, an adjustment coefficient of the minimum safe speed is α=0.15, an adjustment coefficient of the maximum safe speed is β=0.25, and the gait coefficient is n=0.5.
(4) Control module, configured to generate, based on the planned path and the movement strategy with reference to the voice instruction of the user and a pushing and pulling force of the user, a walking prompt instruction and a drive instruction used for driving the quadruped drive device.

The control module coordinates work of the modules, compares a path planning result with a current position of the user, provides user guidance with reference to the voice interaction module and the haptic feedback module, feeds back a travel direction and an obstacle position to the user in real time through voice reminding and haptic feedback, and implements emergency stopping and obstacle avoidance decisions. When an obstacle ahead or a complex environment change is detected, the intelligent robotic guide dog can automatically stop or adjust a path, to avoid collision, thereby ensuring that the robot can intelligently navigate to a destination.

In the present example, the control module selects a high-performance industrial-level processor, for example, a multi-core ARM processor or an Intel high-performance processor, has a strong computing capability and a multitasking processing capability, can quickly process a large amount of data from the sensor, and efficiently coordinate work of the modules. Multi-layer cabling and an electromagnetic shielding technology are used in a hardware circuit design thereof, to ensure stability and interference immunity of signal transmission, and ensure reliable operation in a complex electromagnetic environment. The control unit is further equipped with a large-capacity cache and memory, and a high-speed communication interface, such as an Ethernet interface, a USB interface, and a CAN bus interface, configured to perform fast data transmission and communication with other modules.
(5) Haptic feedback module, where the haptic feedback module includes a vibration device and a force sensor configured to sense the pushing and pulling force of the user, and the vibration device is configured to provide haptic vibration feedback based on the walking prompt instruction.

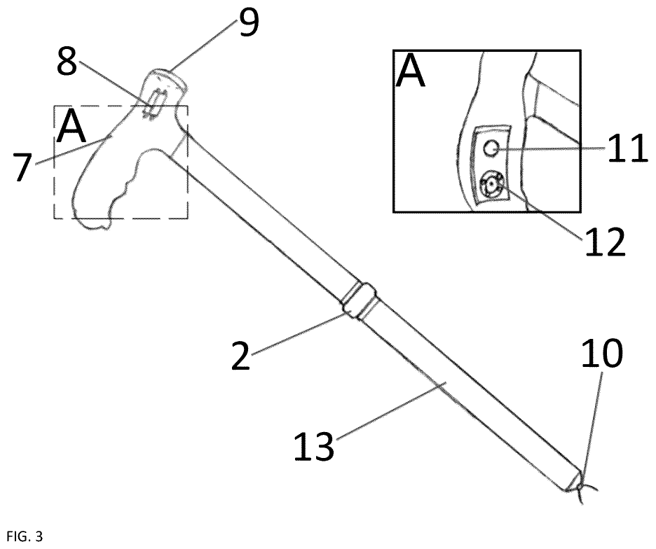

As shown in FIG. 3, the guide cane 1 is a traction guide cane, including a guide cane shaft 13, wherein the guide cane shaft includes a handle 7 and a folding joint 2, and the guide cane shaft may be folded by using the folding joint 2, for ease of being stowed. A battery 8 and a indicator light 9 are installed in the handle 7, the indicator light is powered by the battery, and warning is performed by using the indicator light. A tail of the guide cane shaft includes a traction connection device 10, and the guide cane shaft is connected to the robotic guide dog main body by using the traction connection device 10. The guide cane shaft is further provided with a haptic feedback module, and the haptic feedback module includes a vibration device 11 and a force sensor 12, and performs haptic interaction with the user by sensing the pushing and pulling force of the user and the vibration feedback.

In the present example, a guide cane traction device of the haptic feedback module is formed with a solid and robust high-strength engineering plastic, to ensure stable structural performance in various use scenarios, and provide reliable holding experience for the user. The design of the guide cane conforms to an ergonomic principle, and a surface of the guide cane is especially anti-slip processed, to not only effectively prevent a hand of the user from slipping in a holding process, but also provide a comfortable touch feeling for the user. In addition, a high-precision force sensor is integrated inside the guide cane. The element uses an advanced piezoresistive sensing technology, and can precisely sense changes of a pushing force and a pulling force that are exerted by the user on the guide cane. When the pushing force of the user is detected, a rotational speed of a drive motor in the drive instruction is adjusted based on a change degree of the pushing force with reference to a preset acceleration rule, to adjust the robotic guide dog for a smooth acceleration; and when the pulling force of the user is detected, the rotational speed of the drive motor in the drive instruction is adjusted based on a change degree of the pulling force with reference to the preset acceleration rule, to adjust the robotic guide dog for a smooth deceleration.

Specifically, when the user pushes the guide cane forward, the force sensor rapidly captures a pressure change generated by the action, converts the pressure change into an electrical signal, and transmits the electrical signal to the control module. After receiving the electrical signal, the control module adjusts, according to the preset acceleration rule, the rotational speed of the drive motor of the robotic guide dog, to implement smooth acceleration of the robotic guide dog. Similarly, when the user pulls the guide cane backward, the control module controls, based on a signal fed back by the force sensor, the drive motor to reduce the rotational speed, so that the robotic guide dog gradually decelerates. In this way, the user can control a travel speed accurately and flexibly. The preset acceleration rule actually reflects a relationship between a pushing and pulling force exerted by the user and speed control, which may be represented by using the following formula:

$$Δ v = k \cdot sign ( F ) \cdot {\vert F \vert}^{n} ;$$

wherein, F represents a pushing and pulling force exerted by the user on the guide cane; Δv represents a speed adjustment amount of the robotic guide dog; k is a proportionality coefficient, and may be adjusted based on a user preference and a system design; sign (F) is a sign function indicating a direction of the pushing and pulling force, is positive when pushed forward, and is negative when pulled backward; and n is an index, used for controlling a non-linear relationship between a pushing and pulling force and speed adjustment.

In addition, the vibration device is configured to be capable of a multi-mode vibration feedback mechanism, and can transfer different pieces of haptic information to the user based on different environmental situations and navigation requirements (the user is prompted to accelerate, decelerate, or stop through changes in vibration frequency and intensity). A dynamic adjustment function of the haptic module is implemented based on the environment sparsity and the user real-time speed that are obtained through calculation. The environment sparsity is a function used for quantifying an obstacle density and a pedestrian density in the current environment, and reflects complexity and congestion of the environment. The function calculates, in real time by using sensor data (such as the LiDAR and the camera), distribution of obstacles and a quantity of and speeds of pedestrians in the environment, and outputs a sparsity indicator. A higher sparsity indicator indicates a more open environment and fewer obstacles, and a lower sparsity indicator indicates a more complex environment, more obstacles, or a higher pedestrian density. The environment sparsity function is used for dynamically adjusting a vibration mode of the haptic feedback module, to prompt the user to adjust a walking speed or take an obstacle avoidance measure. When the environment is complex or the user needs to slow down, a vibration motor is switched to a vibration mode with a medium frequency, a medium intensity, and a long time, to prompt the user to slow down; when the environment is sparse or the user needs to increase a walking speed, the vibration motor is switched to a vibration mode with a low frequency, a low intensity, and a long time, to prompt the user to speed up; and when an actual travel speed of the user is within a safe speed interval, the vibration motor keeps still, to inform the user that a current travel state is normal.

Specifically, the vibration device installed on the guide cane uses a high-performance eccentric rotating mass (ERM) vibration motor. The motor has features of a fast response speed, rich vibration modes, and precise adjustment. The vibration motor is closely connected to an environment sensing module (that is, the vision module), a path planning module (that is, the data processing module), and a decision-making module (that is, the control module) of the robot by using a specially designed control circuit. The control circuit uses an advanced microcontroller unit (MCU), and can precisely control a vibration frequency, intensity, duration, and a vibration mode of the vibration motor based on information from different modules.

In the present example, the walking prompt instruction includes a voice prompt instruction and a haptic feedback prompt instruction, and the control module generates the voice prompt instruction and the haptic feedback prompt instruction based on a current planned path and the movement strategy with reference to an obstacle identified on the current path.
(5.1) The generating the haptic feedback prompt instruction based on the currently detected obstacle, the vibration device performing vibration feedback of a set frequency, intensity, and duration based on the haptic feedback prompt instruction includes:
when the environment sensing module detects that there is an obstacle 1 m ahead, the control circuit may quickly adjust a parameter of the vibration motor, so that the vibration motor works in a vibration mode with a high frequency (5 Hz), a high intensity (80% of a maximum output power of the motor), and long duration (lasts for 10 seconds). The user is reminded in time through strong vibration that there is a danger ahead, and needs to immediately stop traveling.
(5.2) The comparing a current required walking speed with a real-time speed of the user, and generating a corresponding haptic feedback prompt instruction based on a comparison result, the vibration device performing vibration feedback based on the haptic feedback prompt instruction includes:
when a current speed V_{current} of the blind is higher than Vₘₐₓ, the vibration motor switches to a vibration mode with a medium frequency (2 Hz), a medium intensity (50% of the maximum output power of the motor), and long duration (lasts for 5 seconds), to prompt the user to slow down;
when the current speed V_{current} of the blind is lower than Vₘᵢₙ, the vibration motor switches to a vibration mode with a low frequency (1 Hz), a low intensity (30% of the maximum output power of the motor), and long duration (lasts for 5 seconds), to prompt the user to speed up; and
when the actual travel speed of the user is within an interval of [Vₘᵢₙ, Vₘₐₓ], the vibration motor keeps still, to inform the user that a current travel state is normal.

In addition, the vibration device also supports personalized setting. The user may flexibly adjust strength, frequency, and mode of vibration based on sensitivity and a use habit of the user on an operation interface connected to the voice interaction module. The haptic feedback module further has a safety enhancing function. When it is detected that an obstacle ahead is excessively close, the haptic module prompts, through high-frequency combined vibration, the user to stop immediately. When the robot detects an emergency, the vibration device vibrates at a highest frequency (10 Hz) and a highest intensity (100% of the maximum output power of the motor) under an action of the control circuit, and in combination with an emergency voice prompt sent by the voice interaction module, sends an emergency alarm to the user in a double-pronged manner, to ensure that the user can make a corresponding response in the first time, thereby greatly improving safety of the system.

The system provided in the present example can implement the following functions.

Visual-haptic fusion: the vision module captures dynamic information in an environment by using a camera and a radar sensor. The data processing module obtains, through calculation, a safe speed for the user to walk, and transmits this information to the haptic module through the control module. The haptic module adjusts the vibration frequency based on the safe speed for the user to walk, and prompts the user to adjust a walking speed. For example, when it is detected that a crowd speed increases, it means that the environment is more complex. In this case, if the comparison result is that the current speed of the blind is greater than the maximum safe speed, to ensure safe and efficient walking of the user, the haptic module may increase the vibration frequency based on received comparison result information, and prompts the user to slow down. When it is determined by using the algorithm that the environment is sparse, in this case, if the comparison result is that the current speed of the blind is less than the minimum safe speed, the haptic module reduces the vibration frequency, to prompt the user to speed up, so that the user can intuitively sense an environment change through haptic feedback, and adjust the walking speed in time.

Audio-haptic fusion: the voice interaction module provides a voice instruction, such as “Turn left”, “Turn right”, “There are many pedestrians ahead, please slow down”, or “There is an obstacle ahead” to the user in real time based on a path planning result, and the haptic module synchronizes with the voice instruction through vibration feedback, to enhance a sensing capability of the user. For example, when the voice prompt is “There is an obstacle ahead”, the haptic module performs feedback at a corresponding vibration frequency and intensity based on a distance from the obstacle and a danger level of the obstacle. For example, when the obstacle is close, high-frequency and high-intensity vibration is used, so that the user obtains information from both audio and haptic aspects, thereby dealing with an environment change more accurately.

Audio-visual-haptic comprehensive feedback: in a complex environment, the vision module, the auditory module, and the haptic module work together to ensure that the user can receive navigation information through a plurality of senses. For example, when it is detected that there is an obstacle ahead, the vision module identifies a position of the obstacle, the voice module makes an alarm, and the haptic module prompts, through high-frequency vibration, the user to stop or bypass. A shopping mall is used as an example. The vision module identifies positions of obstacles such as pedestrians and shelves ahead in real time by using the camera and the LiDAR, and transmits information to other modules. The voice module makes an alarm such as “There are pedestrians ahead, please be careful and give way” or “There are shelves ahead, please go around” based on the information. The haptic module prompts, based on a distance from the obstacle and a danger level of the obstacle, the user to stop or go around through high-frequency vibration. When the user approaches the shelves, high-frequency vibration of the haptic module prompts the user to stop in time, and the voice prompt further clarifies a dangerous condition, so that the user can quickly make a response, thereby effectively avoiding collision, and ensuring travel safety.

Through visual-haptic fusion, audio-haptic fusion, and audio-visual-haptic comprehensive feedback described above, efficient, intelligent, and safe travel assistance can be implemented.

### Example 2

The present example provides an intelligent assistive blind guidance method based on audio-visual fusion and haptic feedback, which is implemented based on the intelligent assistive blind guidance system based on audio-visual fusion and haptic feedback proposed in Embodiment 1, and includes:
sensing surrounding environment information in real time, receiving a voice instruction of a user, and sensing a pushing and pulling force of the user for a guide cane;
constructing a surrounding environment map based on the received surrounding environment information, and generating a planned path and a movement strategy with reference to the voice instruction of the user, the movement strategy including a current required walking speed; and
generating a walking prompt instruction and a drive instruction based on the planned path and the movement strategy with reference to the voice instruction of the user and the pushing and pulling force of the user, performing haptic vibration feedback and voice feedback based on the walking prompt instruction, and driving a robotic guide dog to perform assistive blind guidance based on the drive instruction.

### Example 3

The present example provides an electronic device, including: a memory, configured to store an executable instruction; a processor, configured to implement, when executing the executable instruction stored in the memory, the method provided in the present example.

### Example 4

The present example further provides a computer-readable storage medium storing an executable instruction. When the executable instruction is executed by a processor, the processor is caused to perform the method provided in the present example.

### Example 5

The present example provides a computer program product, the computer program product includes an executable instruction, and the executable instruction is a computer instruction. The executable instruction is stored in a computer-readable storage medium. When a processor of an electronic device reads the executable instruction from the computer-readable storage medium, the processor executes the executable instruction, so that the electronic device performs the method provided in the present example.

The steps in Example 2 to Example 5 correspond to those of Example 1. For specific implementations, refer to the relevant description part of Example 1. The term “computer-readable storage medium” should be understood as a single medium or a plurality of media including one or more instruction sets. It should alternatively be understood as including any medium that can store, code, or carry an instruction set for being executed by the processor and cause the processor to perform any method in the present invention.

A person skilled in the art should understand that the modules or steps of the present invention may be implemented by using a general-purpose computer device. Optionally, the modules or steps may be implemented by using program code that can be executed by a computing device, so that the modules or steps may be stored in a storage device and executed by the computing device, or the modules or steps are separately manufactured into various integrated circuit modules, or a plurality of modules or steps thereof are manufactured into a single integrated circuit module for implementation. The present invention is not limited to any particular combination of hardware and software.

The foregoing descriptions are merely preferred embodiments of the present invention. The specific implementations of the present invention are described above with reference to the accompanying drawings, but not for limiting the protection scope of the present invention. A person skilled in the art should understand that, based on the technical solutions of the present invention, various modifications or changes made by a person skilled in the art without creative efforts still fall within the protection scope of the present invention.

1. An intelligent assistive blind guidance system based on audio-visual fusion and haptic feedback, wherein the system comprises a robotic guide dog and a guide cane, the robotic guide dog comprises a robotic guide dog main body and a quadruped drive device, and the robotic guide dog main body comprises:
a vision module, configured to sense surrounding environment information in real time;
a voice interaction module, configured to: perform voice interaction with a user, receive a voice instruction of the user, and feed back a voice navigation prompt based on a walking prompt instruction;
a data processing module, configured to: construct a surrounding environment map based on received surrounding environment information, and generate a planned path and a movement strategy with reference to the voice instruction of the user, the movement strategy comprising a current required walking speed; and
a control module, configured to generate, based on the planned path and the movement strategy with reference to the voice instruction of the user and a pushing and pulling force of the user, a walking prompt instruction and a drive instruction used for driving the quadruped drive device;
wherein, a top handle of the guide cane comprises a haptic feedback module, the haptic feedback module comprises a vibration device and a force sensor configured to sense the pushing and pulling force of the user, and the vibration device is configured to provide haptic vibration feedback based on the walking prompt instruction;
the generating a movement strategy comprises:
calculating an environment sparsity based on a quantity of pedestrians, a pedestrian speed, and a distance between the robotic guide dog and a nearest obstacle that are detected in real time in a current scenario, wherein a calculation formula is:
$$A = \frac{1}{{k}_{1} \cdot N + {k}_{2} \cdot {V}_{avg} + {k}_{3} \cdot \frac{1}{{d}_{min}}} ;$$
wherein, N is a quantity of pedestrians detected in a current environment, V_{avg} is an average speed of pedestrians in the current environment, the pedestrian in the environment is detected by using a camera and a light detection and ranging (LiDAR), and a speed vᵢ of each pedestrian is calculated, to further calculate an average speed of pedestrians in a crowd by using
$${V}_{avg} = \frac{1}{N} {\sum }_{i = 1}^{N} {v}_{i} ;$$
dₘᵢₙ is the distance between the robotic guide dog and the nearest obstacle, and is detected and obtained by using the LiDAR or an ultrasonic sensor; and k₁, k₂, and k₃ are weight coefficients, used for adjusting impact of the quantity of pedestrians, the pedestrian speed, and the distance from the obstacle on the environment sparsity;
calculating a current real-time speed of a blind user based on a motion state of the robotic guide dog; and
generating a current required walking speed, that is, a recommended walking speed of the user based on the environment sparsity with reference to a preset reference walking speed of the user, wherein the recommended walking speed of the user comprises a minimum safe speed Vₘᵢₙ and a maximum safe speed Vₘₐₓ recommended for the user to walk:
$${V}_{min} = {V}_{base} \cdot ( 1 - α \cdot ( 1 - A ) ) ;$$
$${V}_{max} = {V}_{base} \cdot ( 1 + β \cdot A ) ;$$
wherein, V_{base} is a reference walking speed of the user; and, a and B are adjustment coefficients, used for controlling a safe speed range.

2. The intelligent assistive blind guidance system based on audio-visual fusion and haptic feedback according to claim 1, wherein the constructing a surrounding environment map based on received surrounding environment information, and generating a planned path with reference to the voice instruction of the user comprises:
detecting and identifying, in real time, a surrounding terrain, types and states of static and dynamic obstacles, and the motion state of the robotic guide dog based on the obtained surrounding environment information;
performing environment analysis based on identified data, and constructing a high-definition map;
performing environment analysis and optimal path planning by using an improved A* algorithm in combination with a deep reinforcement learning algorithm based on a constructed map model and destination information clarified based on the voice instruction of the user, and searching for an optimal path from a current position to a destination on the map, wherein the improved A* algorithm is dynamically selecting the optimal path based on an evaluation value by using an evaluation function that introduces a dynamic weight adjustment mechanism and a local re-planning mechanism and integrates user preference; and
adjusting the planned path in real time, and dynamically selecting and updating a travel route based on a real-time surrounding environment and a user requirement.

3. The intelligent assistive blind guidance system based on audio-visual fusion and haptic feedback according to claim 1, wherein the walking prompt instruction comprises a voice prompt instruction and a haptic feedback prompt instruction, and that the control module generates the voice prompt instruction and the haptic feedback prompt instruction based on a current planned path and the movement strategy with reference to an obstacle identified on the current path comprises:
generating the voice prompt instruction and the haptic feedback prompt instruction based on the currently detected obstacle, the voice interaction module performing obstacle voice prompt based on the voice prompt instruction, and the vibration device performing vibration feedback of a set frequency, intensity, and duration based on the haptic feedback prompt instruction; and
comparing a current required walking speed with a current real-time speed of the user, and generating haptic feedback prompt instructions of different vibration levels based on a comparison result, the vibration device performing vibration feedback of a corresponding vibration level based on the haptic feedback prompt instruction, wherein the different vibration levels comprise different vibration frequencies, intensities, and durations.

4. The intelligent assistive blind guidance system based on audio-visual fusion and haptic feedback according to claim 3, wherein the vibration device performing vibration feedback of a corresponding vibration level based on the haptic feedback prompt instruction comprises:
prompting acceleration by using a low frequency, low intensity, and long-time vibration when the current real-time speed of the user is lower than the minimum safe speed;
prompting deceleration by using a medium frequency, medium intensity, and long-time vibration when the current real-time speed of the user is higher than the maximum safe speed; and
stopping vibration when the current real-time speed of the user is within the safe speed range.

5. The intelligent assistive blind guidance system based on audio-visual fusion and haptic feedback according to claim 1, wherein in the control module, adjusting the drive instruction based on the planned path and the movement strategy with reference to the pushing and pulling force of the user, to adjust a travel speed of the robotic guide dog comprises:
adjusting, when a pushing force of the user is detected, a rotational speed of a drive motor in the drive instruction based on a change degree of the pushing force with reference to a preset acceleration rule, to adjust the robotic guide dog for a smooth acceleration; and
adjusting, when a pulling force of the user is detected, the rotational speed of the drive motor in the drive instruction based on a change degree of the pulling force with reference to the preset acceleration rule, to adjust the robotic guide dog for a smooth deceleration, wherein the preset acceleration rule reflects a relationship between the pushing and pulling force applied by the user and speed control.

6. An intelligent assistive blind guidance method based on audio-visual fusion and haptic feedback, implemented based on the intelligent assistive blind guidance system based on audio-visual fusion and haptic feedback according to claim 1, and comprising:
sensing surrounding environment information in real time, receiving a voice instruction of a user, and sensing a pushing and pulling force of the user for a guide cane;
constructing a surrounding environment map based on the received surrounding environment information, and generating a planned path and a movement strategy with reference to the voice instruction of the user, the movement strategy comprising a current required walking speed; and
generating a walking prompt instruction and a drive instruction based on the planned path and the movement strategy with reference to the voice instruction of the user and the pushing and pulling force of the user, performing haptic vibration feedback and voice feedback based on the walking prompt instruction, and driving a robotic guide dog to perform assistive blind guidance based on the drive instruction.

7. An electronic device, comprising:
a memory, configured to store an executable instruction; and a processor, configured to implement, when executing the executable instruction stored in the memory, the intelligent assistive blind guidance method based on audio-visual fusion and haptic feedback according to claim 6.

8. A non-transitory computer-readable storage medium, storing an executable instruction, and configured to cause a processor, when executing the executable instruction, to implement the intelligent assistive blind guidance method based on audio-visual fusion and haptic feedback according to claim 6.
